(19) United States
(12) Patent Application Publication
(10) Pub. No.: US 2021/0034764 A1
(43) Pub. Date: Feb. 4, 2021

(54) CRYPTOGRAPHIC SERVICES IN PRINT APPARATUS

(71) Applicant: Hewlett-Packard Development Company, L.P., Spring, TX (US)

(72) Inventors: Helen Balinsky, Bristol (GB); Alberto Such Vicente, Sant Cugat del Valles (ES); Chris Dalton, Bristol (GB); Remy Husson, Bristol (GB)

(73) Assignee: Hewlett-Packard Development Company, L.P., Spring, TX (US)

(21) Appl. No.: 16/980,046

(22) PCT Filed: Apr. 24, 2018
(86) PCT No.: PCT/US2018/029153

§ 371 Date: Sep. 11, 2020

(51) Int. Cl. G06F 21/60; G06F 3/12; H04L 9/32

(52) U.S. Cl. CPC G06F 21/602; G06F 21/608; H04L 9/3247; G06F 3/1238; G06F 3/1222

(57) ABSTRACT

In an example, print apparatus comprises a security services engine to perform cryptographic services. The security services engine may receive a request for a cryptographic service and validate that the request is an authorised request. On successful validation, the security services engine may perform the cryptographic service by acquiring a first key, acquire an associated first key identifier and may output the first key identifier.

### BACKGROUND

Printing may comprise 2D and 3D printing (also referred to as additive manufacturing). 2D printing may comprise applying print agent to a substrate, 3D printing may comprise forming a 3D object in a layer-by-layer manner. In one example of additive manufacturing, an object is generated by solidifying portions of layers of build material. In other examples, 3D objects may be generated using extruded plastics or sprayed materials as build materials, which solidify to form an object.

Additive manufacturing (3D printing) systems and 2D printing systems may generate printed outputs based on design data. Some printing systems use control data generated from such design data. This control data may, for example, specify the locations at which to apply a print agent.

### BRIEF DESCRIPTION OF DRAWINGS

Non-limiting examples will now be described with reference to the accompanying drawings, in which:

FIG. 1 is a representation of an example of a print apparatus;

FIG. 2 is a representation of an example of an additive manufacturing apparatus;

FIG. 3 is a flowchart of an example method of providing access to cryptographic services;

FIG. 4 is a flowchart of another example method of providing access to cryptographic services; and

FIG. 5 is a representation of an example of a processor in association with a machine readable medium.

### DETAILED DESCRIPTION

Design data for 2D and 3D printing systems can have considerable value. For example, designs may be generated using considerable skill and labour and thus have a value to the designer or another owner of the data. As such, it may be intended to protect the data, for example by encryption and the like, and/or to ensure its authenticity and/or integrity Design data may for example represent a new and/or experimental prototype of a future product, and maintaining confidentiality may protect a competitive advantage of the product owner. In another example, design data could contain private (e.g. personal, or patient) data, such that confidentiality should be maintained. In a further example, design data could characterise or illustrate a high value product which is to be protected under rights management for manufacturing. However, in order to generate a printed output to the design data, the data may be exposed, for example to generate control instructions to allow the object/print out to be generated.

In addition, in some examples, there may be limits applied to the use of design data, for example a maximum number of objects/print outs that may be generated and/or a valid license may be required.

Print apparatus themselves may be distributed to any number of locations which may place them in locations which are vulnerable to malicious attackers Thus, any cryptographic processes and material provided as part of the processing circuitry of such apparatus may also be vulnerable.

Additive manufacturing techniques may generate a three-dimensional object through the solidification of a build material. This may be carried out in a layer-by-layer manner and, in some such examples, a digital model can be processed to generate slices of parallel planes of the model. Each slice may define a portion of a respective layer of build material that is to be solidified or caused to coalesce by the additive manufacturing system. The properties of generated objects may depend on the type of build material and the type of solidification mechanism used. Build material may be deposited, for example on a print bed and processed layer by layer, for example within a fabrication chamber, in examples, three-dimensional objects may be generated using heat, adhesives, curing agents, extruded plastics, sprayed materials or the like which solidify or cause solidification to form an object.

In some examples, the build material may be a powder-like granular material, which may for example be a plastic, ceramic or metal powder. Selective solidification may be achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated. The fusing agent may have a composition which absorbs energy such that, when energy (for example, heat) is applied to the layer, the build material coalesces and solidifies to form a slice of the three-dimensional object in accordance with the pattern. In other examples, coalescence may be achieved in some other manner.

In some examples herein, print apparatus is configured to minimize and localize access to cryptographic material. For example, the arrangement may be such that only authorized in-device applications (e.g. applications running in processing resources of a print apparatus) and services may request cryptographic functions, and such functions may be performed without giving the requesting entity access to the actual key materials and/or cryptographic algorithms. This may serve to protect key material from unauthorized access by in-device applications, processes and threads, prevent unauthorized use of cryptography and/or to minimize a “surface of attack” for confidential cryptographic material.

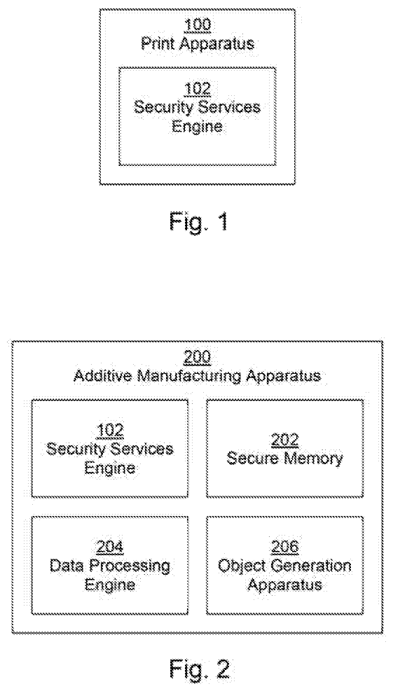

FIG. 1 shows an example of a print apparatus 100 comprising a security services engine 102 which, in use of the print apparatus 100, performs a cryptographic service, in some examples, the print apparatus may be a 20 or 3D (additive manufacturing) print apparatus, in some examples, the security services engine 102 comprises processing circuitry. In some examples, the security services engine 102 is provided within a secure processing enclave. For example, the security services engine 102 may comprise an isolated and/or dedicated cryptographic processor, a hardware supported isolated software enclave, and/or a service hosted in an isolated virtual machine or the like. In some examples, the security services engine 102 is an embedded system (i.e. a processing resource which is designed to carry out a specific function—in this case a security service function—within the print apparatus).

In use of the apparatus 100, the security services engine 102 may receive a request for a cryptographic service. For example, the cryptographic service may comprise at least one of data encryption, data decryption, data validation, data signing, or the like.

The security services engine 102 may validate that the request is an authorised request. The validation may comprise a validation that the request is an authorised request to use a particular service, and/or an authorised request to use a particular key in performing the cryptographic service. For example, these may comprise validation of at least one policy, identity, token, or the like. By validating both a request for the use of the service and for the use of a key, fine-grained access control may be implemented. In some examples, the validation of the request may have two stages: authentication and authorisation Authentication may comprise validating the identity of the application/component requesting the service and authorization may comprise validating that the requesting application/component has the appropriate rights to perform the operation and/or to access the service. In some examples, authorisation may be exhausted, for example after a predetermined number of print outputs have been produced, or after a single use of the service, or the like.

On successful validation, the security services engine 102 then performs the cryptographic service by acquiring a first key and further acquires an associated first key identifier. The first key identifier is then output, for example to the requesting entity.

On failure to validate, the security services engine 102 may prevent execution of the cryptographic service.

In one example, the cryptographic service is performed in the context of a hybrid cryptosystem, in such a system, two entities need not share a common secret m order to communicate securely. For example, an object design may be encrypted based on one secret (e.g. a cryptographic key), but access to the secret need not be provided in order for the design to be decrypted. For example, the request for the cryptographic service may comprise an encapsulated key, which is encapsulated using a public key encryption and encapsulated data, which is encapsulated using a private (e.g. symmetric) key encryption. As public key encryption is demanding on resources, in such a scheme, the amount of data which is protected by public key encryption is relatively small, i.e. just the key.

In other words, in such schemes, key exchange may take place using asymmetric/public key encryption, with data being protected by that key (or key material derivable from such a key).

For example, an object design may be intended to be decrypted by the security services engine 102. A first entity, which may be a source or owner of the design data, obtains the public key for the security services engine 102 and acquires the first key, which in this example is a symmetric key. This is used to encrypt the design, which may then be transmitted to the print apparatus 100, for example via a network or using a memory storage resource of the tike, along with the first key which is encrypted using the public key. This may for example be provided as an encrypted message.

The security services engine 102 may use a private key to decrypt the first key, and in turn use the first key to decrypt the design. In other examples, the decrypted key may be used to perform some other additional (cryptographic) service, such as decrypting or encrypting any data, signing data, verifying a signature or the like.

Thus, in a particular example, the request may comprise object model data representing a first three-dimensional object, which may be encrypted using the first key, and the first key, which may be encrypted using a second key. The object may be an object to be generated in additive manufacturing. The data may for example comprise a voxel representation of an object (described in greater detail below), or a ‘wireframe’, mesh or vector representation of the object. In some examples, the data may comprise a representation of the object's surface. The data may for example be stored using a 3MF format, Stereolithography (STL) file format, OBJ file format, or any other file format capable of representing a three dimensional object.

In some examples, the object model data may be suitable to provide an input into an additive manufacturing workflow, and may comprise all the design data necessary for object generation. In some examples, the object model data may be suitable to allow an object to be generated at least substantially automatically. In other words, although processing of the data may be carried out in order to develop control data for generating the object, it may be the case that such processing will not comprise developing design data or substantial user/designer input. In some examples, the object model data may be or comprise control data to control an additive manufacturing apparatus to generate the object, for example comprising control data or instructions for an additive manufacturing apparatus. In other examples, the object model data may be processed, for example using mapping tables, to determine what materials are to be used in generating the object, and processing (for example, halftoning) to determine where the materials should be placed, and the like.

Such object model data may be received as a single file or as multiple data objects. In some examples, the object model data may be provided in terms of voxels (three dimensional pixels) that are defined in a three-dimensional (also referred to herein as [x,y,z]) space. A given voxel may have an attribute. For example, a voxel may be associated with data that indicates whether a portion of the model object is present at that location, in some examples, object property values (for example as defined in object property data) may be associated with each voxel as an attribute thereof. Object property data may thereby be associated with a set of voxels, e.g. ranging from individual voxels to all voxels associated with the object.

For example, object model data may describe a number of voxels, each of which has an intended relative location in space. The voxels may populate the solid regions of the object in relation to at least one of those voxels, at least one property value may be specified: for example, a particular voxel may be red (or a particular red) and transparent, while another voxel may be blue and have a particular density. In one example, the object model data comprises a model of a three-dimensional object that has at least one object property specified at every location within the model, e.g. at every [x, y, z] co-ordinate.

As set out above, the first key is not released to the requesting entity, which may be a process, service, application, thread or the like running on the apparatus 100. Instead, an identifier for the first key is released. This minimizes risk of exposure of sensitive key material by limiting access to the key material to particular requesting entities. Furthermore, such requesting entities are not provided direct access to cryptographic material but instead are authenticated and provided with ability to request the functionality from an independent secure service provided by the security services engine 102.

By issuing the key identifier, a requesting entity (e.g. a client application) can perform further cryptographic operations using the key. For every new operation it requests, the system may be configured such that the requesting entity does not need to fetch the key again from first principles but instead uses the key identifier to identify it. Such further operations may also be validated for authorization.

In other words, key identifier is released so that the requesting entity can specify which key it wants to use when calling a cryptographic service in some cases, ft is possible that multiple applications share the right to use the same key. For example, an application App1 may call a cryptographic service resulting in the creation of a key identified by its key identifier keyID1 If the access control rules/policy allow it. App1 could communicate keyID1 to another application App2, and App2 could use keyID1 to perform authorized cryptographic operations with the key identified by keyID1.

Alternatively, App1 and App2 could have different key identifiers to the same key and as such could be unaware that they are sharing key material, which may reduce the risks associated with sharing key material in other examples, the same keyID may be used by more than one application. For example, there may be “general access” keys for use by more than one application and “single use” keys for use by just one application.

In some examples, the cryptographic service associated with the key need not be carried out immediately. For example, the requesting entity may hold the key identifier when required, and then may refer to the key to which access is sought using the identifier.

In some examples, as the applications are authenticated, access control rules can be updated whenever a key is created to allow a requesting application to use a key associated with an issued key identifier in the future There may be conditions on the use, such as a maximum number of times for use.

In some examples, the first key may be acquired in some other way, for example be retrieved from a memory (which may for example comprise hardware specifically to store keys, such as a trusted platform module TPM). In some examples, at least one key may be stored in a memory as the apparatus 100 is being manufactured and may in some examples be available for use for the whole lifetime of the apparatus 100. In other examples, the first key may be generated using key generation algorithms (for example, based on random and/or pseudo random number generation, but with additional processes to result in predetermined characteristics). In some examples, the first key may be derived from another pre-existing key, for example using a key derivation function. In some such examples, a single master key may be the source of a number of ‘child keys’.

Thus, the security services engine 102 may be a “high privilege process/service” which holds and controls access to (“owns”) cryptographic material in the apparatus 100. In some examples, the security services engine 102 may own all the cryptographic material. The security services engine 102 may perform requested cryptographic operations for applications/services and may use fine-grained authorized per key and/or per identity cryptographic services. Multiple features, services, protections and the like could be used to shield the security services engine 102 from any compromise or tampering such as using software and/hardware based isolation.

In some examples, the security services engine 102 may receive a subsequent request, the subsequent request comprising a request to perform a cryptographic service using the first key, wherein the request comprises the first key identifier.

In one example, in a subsequent request for a cryptographic service from a first application, which has access to/has previously been issued the key identifier keyID, the security services engine 102 retrieves corresponding key material (as requested by the first application using the keyID), then may (subject to validation/verification) perform the requested cryptographic service. The security services engine 102 may return the results of the operation performed to the requesting application. For example, the results of a successful operation, performed by the security services engine 102, could be:
a) decrypted data, if the first application requested decryption, whilst providing encrypted data and a key identifier
b) encrypted data, if the first application requested encryption, whilst providing clear-text data and a key identifier
c) digital signature value, if the first application requested digital signing, whilst providing data-to-be-signed and a key identifier
d) Boolean valid/invalid, if the first application requested signature validation, whilst providing signed data and a certificate identifier.

Key material may be securely and exclusively stored, managed and accessed by the security services engine 102.

FIG. 2 shows another example of a print apparatus, in this example an additive manufacturing apparatus 200. The additive manufacturing apparatus 200 comprises, in addition to the security services engine 102 described above, a secure memory 202 which stores cryptographic key material which is accessible to the security services engine 102. The additive manufacturing apparatus 200 further comprises a data processing engine 204 to request cryptographic services and to receive an output of the security services engine. The data processing engine 204 may comprise or host any application, process and/or thread which requests cryptographic functions such as encryption, decryption, data signing, signature verification and the like. In some examples, applications, processes and/or threads and the like cannot perform the functionality by themselves and require the corresponding service from the security services engine 102. In this example, all cryptographic material (public/private/symmetric keys and certificates) is “owned” by the security services engine 102.

In this example, to access the services of the security services engine 102, a requesting process/application/thread, generally identified herein as Pᵢ must first be successfully authenticated by the security services engine 102, which may establish that Pᵢ is what it claims to be and that Pᵢ is authorized to use the requested functionality Upon successful verification, the security services engine 102 performs a cryptographic operation requested by Pᵢ and depending on the type of operation returns the corresponding output to Pᵢ.

As has been described above, if Pᵢ requests public key decryption as part of a hybrid encryption scheme, a recovered symmetric key K may not be returned to Pᵢ, instead the first key may be registered and held by the security services engine 102, which returns a key ID of the first key to Pᵢ.

The security services engine 102 may perform cryptographic services. For example, if Pᵢ requests symmetric encryption/decryption, then encrypted/decrypted data may be returned to Pᵢ by the security services engine 102. If Pᵢ requests a signature or a signature validation, then a Signature value/validation result is returned to Pᵢ by the security services engine 102. In other examples, the security services engine 102 may return a Hash-based Message Authentication Code (HMAC), a certificate validation, a certificate generation, a verification of an HMAC, and the like.

Any access to a cryptographic service may be granted for a session/fixed time period or with other constraints (such as a maximum number of printed outputs). For example, an embedded application, which runs at a particular manufacturing stage, may be authorised to request some crypto services when a device is at the specified stage and not at any others.

Individual Pᵢ processes/application/threads may be granted access to just those cryptographic services which are appropriate for them. These may for example be specified in access control lists or the like. In some examples in order to authorise such processes/services/applications, the security services engine 102 may require a proof of integrity of a requesting entity (for example by authenticating an application), which may be assured by dedicated hardware and/or low level firmware, which provides control for the print apparatus' hardware and/or which may be fixed for the life of the apparatus 100.

The additive manufacturing apparatus 200 in this example further comprises object generation apparatus 206 which, in use of the apparatus 200, generates objects in a build volume. The object generation apparatus 206 may generate objects in a layer-wise manner by selectively solidifying portions of layers of build material. The selective solidification may in some examples be achieved by selectively applying print agents, for example through use of ‘inkjet’ liquid distribution technologies, and applying energy, for example heat, to each layer. The object generation apparatus 206 may comprise additional components not shown herein, for example a fabrication chamber, a print bed, print head(s) for distributing print agents, a build material distribution system for providing layers of build material, energy sources such as heat lamps and the like, which are not described in detail herein.

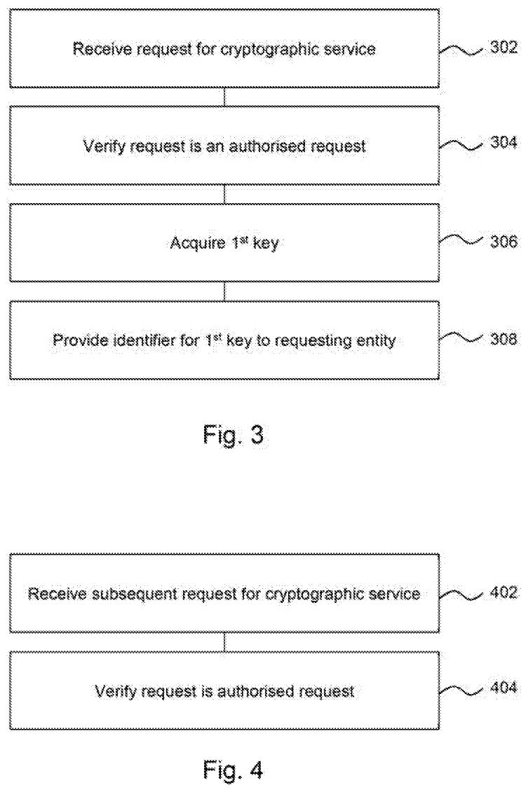

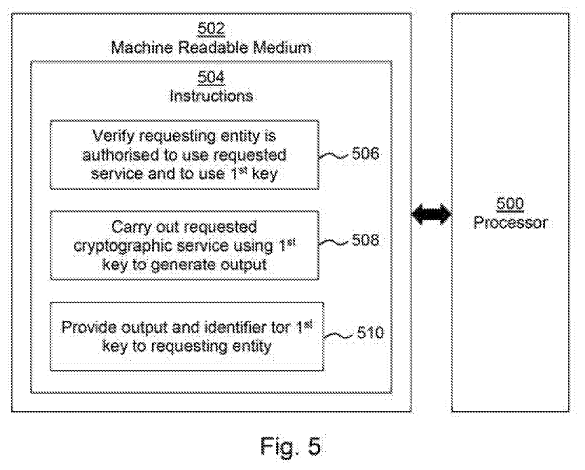

FIG. 3 is an example of a method, which may be implemented using at least one processor, in some examples, the method may be implemented in a secure data processing environment. In some examples, the method may be earned out in an embedded machine with in a print apparatus 100, 200. In some examples, the method may be carried out by a security services engine 102. In some examples, the method may be implemented on a plurality of processing devices, which may comprise a plurality of embedded machines or systems, provided and equipped to perform a specific function and which communicate with one another. In a particular example, while some aspects of the method may be implemented in a secure data processing environment provided on a processing device, other processing devices may communicate with that processing device for cryptographic services.

The method comprises, in block 302, receiving, at a secure enclave of print apparatus processing circuitry, a request for a cryptographic service. Block 304 comprises verifying that the request is an authorised request. In the event of successful validation, the method comprises performing the request by, in block 306 acquiring a first key and, in block 306, providing an identifier for the first key to the requesting entity in the event that the validation is not successful, the method may terminate at block 304.

Verifying that the request is an authorised request in block 304 may comprise verifying that the requested service is authorised for use by the requesting entity and/or verifying that use of the first key is authorised for use by the requesting entity. This may for example use an access control list, security policy, an identity of the requesting entity (for example, the process, application or thread requesting the cryptographic service), a security token or the like. Any such verification may be subject to conditions, such as conditions of use (which may be enforced using digital rights management techniques, for example limiting a number or print outs, or the like), time limits, or the like.

As has been described above, acquiring the first key in block 306 may comprise decrypting the first key, which may form part of the request received at block 302. In some examples, block 306 may comprise retrieving the first key from another resource, for example an associated secure memory resource, based on data received in the request. For example this may comprise selection of the first key from a plurality of first keys based on such data. In some examples, block 306 may comprise deriving the key using a pseudorandom number generator, or an algorithmic technique or the like.

FIG. 4 is another example of a method, which may be earned out after the method of FIG. 3. In this example, the method comprises, in block 402 receiving, at the secure enclave of print apparatus processing circuitry, a subsequent request for a cryptographic service, the subsequent request comprising the identifier for the first key. In this example, the method proceeds in block 404, by verifying that the request is an authorised request, in that the requesting entity is authorised to access the requested service and also authorised to use the first key.

Figures shows a processor 500 in communication with a machine readable medium 502. The machine readable medium 502 comprises instructions 504 which, when executed by the processor 500, cause the processor 500 to carry out a plurality of processes. The instructions 504 comprise instructions 506 which, when executed by the processor 500, cause the processor 500 to, on receipt of a request for a cryptographic service within print (e.g. additive manufacturing) apparatus, verify that (i) the requesting entity is authorised to use the requested service, and (ii) the requesting entity is authorised to use a first key for use in performing the requested service. The instructions 504 further comprise instructions 508 which, when executed by the processor 500, cause the processor 500 to, in the event of successful verification, carry out the requested cryptographic service using the first key to generate an output. The instructions 504 further comprise instructions 510 which, when executed by the processor 500, cause the processor 500 to provide the output and an identifier for the first key to the requesting entity.

In some examples, the output may comprise a design and/or print data of instructions. For example, the output may compose print instructions for controlling a print apparatus to generate a printed output, and the instructions may comprise instructions to output such print instructions. In another example, the output may comprise a signature and/or signature verification.

The machine readable medium 502 may comprise further instructions which, when executed by the processor 500, cause the processor 500 to carry out any of the blocks of FIG. 3 or FIG. 4, or the actions described in relation thereto, or to act as the security services engine 102 of FIG. 1 or FIG. 2.

Examples in the present disclosure can be provided as methods, systems or machine readable instructions, such as any combination of software, hardware, firmware or the like Such machine readable instructions may be included on a machine readable storage medium (including but not limited to disc storage. CD-ROM, optical storage, etc.) having machine readable program codes therein or thereon.

The present disclosure is described with reference to flow charts and block diagrams of the method, devices and systems according to examples of the present disclosure Although the flow diagrams described above show a specific order of execution, the order of execution may differ from that which is depicted. Blocks described in relation to one flow chart may be combined with those of another flow chart. It shall be understood that at least some flows and blocks in the flow charts and block diagrams, as well as combinations thereof can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry may execute the machine readable instructions Thus functional modules of the apparatus and devices (for example, the security services engine 102 or the data processing engine 204) may be implemented by a processor executing machine readable instructions stored in a memory, or a processor operating in accordance with instructions embedded in logic circuitry. The term processor is to be interpreted broadly to include a CPU, processing unit. ASIC, logic unit, or programmable gate array etc. The methods and functional modules may all be performed by a single processor or divided amongst several processors.

Such machine readable instructions may also be stored in a machine readable storage (e.g. a tangible machine readable medium) that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) In the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents ft should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. Print apparatus comprising:
a security services engine to perform cryptographic services;
wherein the security services engine is to:
receive a request for a cryptographic service,
validate that the request is an authorised request;
and, on successful validation, to perform the cryptographic service by acquiring a first key and to acquire an associated first key identifier; and
output the first key identifier.

2. Print apparatus according to claim 1 wherein the security services engine is to receive a subsequent request, the subsequent request comprising a request to perform a cryptographic service using the first key, wherein the request comprises the first key identifier.

3. Print apparatus according to claim 1 wherein the request comprises a request to decrypt the first key and to use the first key in at least one additional service.

4. Print apparatus according to claim 1 further comprising a secure memory, to store cryptographic key material which is accessible to the security services engine.

5. Print apparatus according to claim 1 wherein the security services engine is further to validate that the request is an authorised request to use a particular key in performing the cryptographic service.

6. Print apparatus according to claim 1 wherein the cryptographic service comprises at least one of: data encryption, data decryption, data validation, data signing.

7. Print apparatus according to claim 1 in which the security services engine is provided within a secure processing enclave.

8. Print apparatus according to claim 1 further comprising a data processing engine to request cryptographic services and to receive an output of the security services engine.

9. Print apparatus according to claim 1 further comprising object generation apparatus.

10. A method comprising:
receiving, at a secure enclave of print apparatus processing circuitry, a request for a cryptographic service from a requesting entity;
verifying that the request is an authorised request;
in the event of a successful verification, performing the request, wherein performing the request comprises acquiring a first key; and
providing an identifier for the first key to the requesting entity.

11. The method of claim 10, further comprising receiving, at the secure enclave of the print apparatus processing circuitry a subsequent request for a cryptographic service, the subsequent request comprising the identifier for the first key.

12. The method of claim 10 wherein verifying that the request is an authorised request comprises:
verifying that a use of the requested cryptographic service is authorised; and
verifying that use of the first key is authorised.

13. The method of claim 10 further comprising receiving an encrypted message comprising the first key.

14. Tangible machine readable medium storing instructions which when executed by a processor, cause the processor to:
on receipt of a request for a cryptographic service within print apparatus, verify that
(i) the requesting entity is authorised to use the requested service; and
(ii) the requesting entity is authorised to use a first key for use in performing the requested service;
in the event of successful verification, to carry out the requested cryptographic service using the first key to generate an output; and
to provide the output and an identifier for the first key to the requesting entity.

15. Tangible machine readable medium according to claim 14 wherein the instructions to provide an output comprise instructions to cutout print instructions for controlling the print apparatus to generate a printed output.
